(19) United States
(12) Patent Application Publication
(10) Pub. No.: US 2013/0068941 A1
(43) Pub. Date: Mar. 21, 2013

(54) BORON LINER FOR NEUTRON DECTECTORS FOR WELL LOGGING APPLICATIONS

(71) Applicant: Anton Nikitin, Houston, TX (US)

(72) Inventor: Anton Nikitin, Houston, TX (US)

(73) Assignee: BAKER HUGHES INCORPORATED, Houston, TX (US)

(21) Appl. No.: 13/237,301

(22) Filed: Sep. 20, 2011

(51) Int. Cl. G01V 5/10; G01T 3/06

(52) U.S. Cl. 250/269.4; 250/390.11; 250/389

(57) ABSTRACT

Disclosed is an apparatus for detecting neutrons. The apparatus includes a plurality of neutron detector cells, each detector cell comprising a cathode surrounding an anode wherein the cathode of each cell is common to an adjacent detector cell. A neutron interaction material covers an interior surface of the cathode in each neutron detector cell, the neutron interaction material being configured to emit a charged particle between the cathode and the anode upon interacting with a neutron.

### BACKGROUND

Geologic formations are used for many purposes such as hydrocarbon production, geothermal production and carbon dioxide sequestration. In general, formations are characterized in order to determine if the formations are suitable for their intended purpose.

One way to characterize a formation is to convey a downhole tool through a borehole penetrating the formation. The tool is configured to perform measurements of one or more properties of the formation at various depths in the borehole to create a measurement log.

Many types of logs can be used to characterize a formation. In one type of log referred to as a neutron log, a neutron source and a neutron detector are disposed in a downhole tool. The neutron source is used to irradiate the formation and the neutrons resulting from interactions with atoms in the formation are detected with the neutron detector. A formation property such as density or porosity can be determined from the detected neutrons. It would be well received in the drilling industry if the specific neutron detection efficiency could be improved in order to increase the accuracy of logging measurements. In addition, improvements in the mechanical robustness of the neutron detector necessary to withstand shocks and vibrations in a drilling environment would be appreciated.

### BRIEF SUMMARY

Disclosed is an apparatus for detecting neutrons. The apparatus includes a plurality of neutron detector cells, each detector cell comprising a cathode surrounding an anode wherein the cathode of each cell is common to an adjacent detector cell. A neutron interaction material covers an interior surface of the cathode in each neutron detector cell, the neutron interaction material being configured to emit a charged particle between the cathode and the anode upon interacting with a neutron.

Also disclosed is an apparatus for estimating a property of an earth formation penetrated by a borehole. The apparatus includes: a carrier configured to be conveyed through the borehole; a neutron source disposed at the carrier and configured to irradiate the formation with neutrons; a plurality of neutron detector cells disposed at the carrier, each detector cell having a cathode surrounding an anode wherein the cathode of each cell is common to an adjacent cell; and a neutron interaction material covering an interior surface of the cathode in each neutron detector cell, the neutron interaction material being configured to emit a charged particle upon interacting with a received neutron to generate an electrical pulse between the cathode and the anode in the neutron detector cell that received the neutron; wherein the electrical pulse is used to estimate the property.

Further disclosed is a method for estimating a property of an earth formation penetrated by a borehole. The method includes: conveying a carrier through the borehole; irradiating the formation with neutrons emitted from a neutron source disposed at the carrier; receiving neutrons resulting from an interaction of emitted neutron with the formation with a plurality of neutron detector cells disposed at the carrier, each detector cell in the plurality having a cathode surrounding an anode wherein the cathode of each cell is common to an adjacent detector cell; emitting charged particles from neutron interaction material covering an interior of the cathode in each detection cell receiving a neutron wherein the neutron interaction material is configured to emit a charged particle upon interacting with a neutron; generating electrical pulses using the charged particles; and estimating the property using the electrical pulses.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole neutron tool disposed in a borehole penetrating the earth;

FIGS. 2A and 2B, collectively referred to as FIG. 2, depict aspects of a Boron-10 lined detector and its principle of operation;

FIG. 3 depicts aspects of an assembly of Boron-10 lined detectors;

FIG. 4 depicts aspects of manufacturing Boron-10 lined detectors for use in the detector assembly;

FIG. 5 depicts aspects of lids for sealing a casing containing an integrated cathode structure for a neutron detector; and

FIG. 6 presents one example of a method for estimating a property of an earth formation penetrated by a borehole.

### DETAILED DESCRIPTION

Disclosed are method and apparatus for detecting neutrons in well logging and borehole applications. The method and apparatus provide for increased specific neutron detection efficiency and mechanical robustness necessary to withstand shocks and vibration in downhole environments including while-drilling environments.

A detailed description of one or more embodiments of the disclosed apparatus and method presented herein by way of exemplification and not limitation with reference to the Figures.

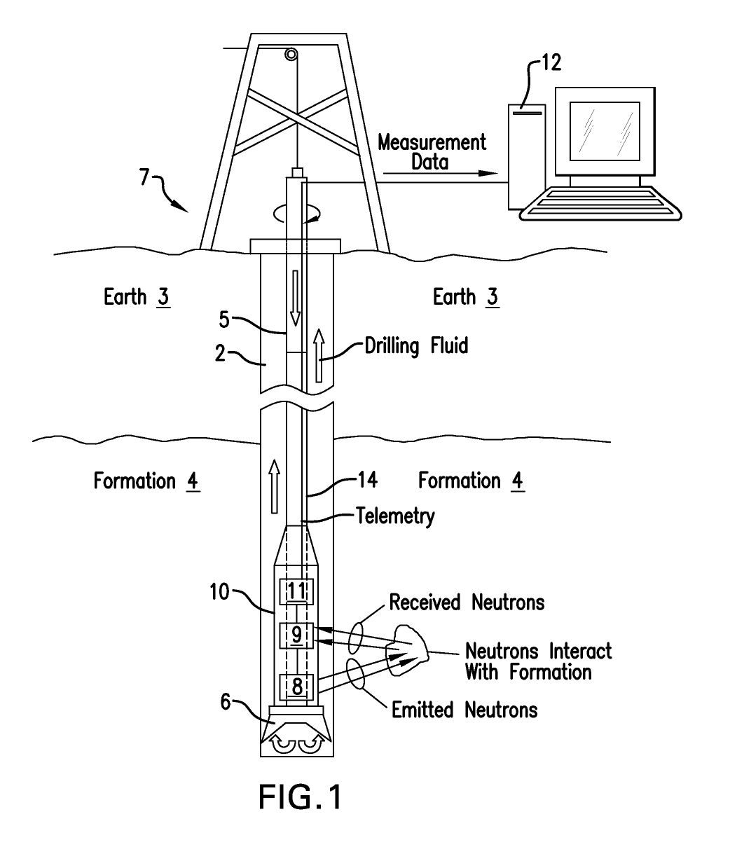

FIG. 1 illustrates an exemplary embodiment of a downhole neutron tool 10 disposed in a borehole 2 penetrating the earth 3, which includes an earth formation 4. The formation 4 represents any subsurface materials of interest. The downhole tool 10 is conveyed through the borehole 2 by a carrier 14. In the embodiment of FIG. 1, the carrier 14 is a drill string 5. Disposed at the distal end of the drill string 5 is a drill bit 6. A drilling rig 7 is configured to conduct drilling operations such as rotating the drill string 5 and thus the drill bit 6 in order to drill the borehole 2. The neutron tool 10 is configured to perform formation measurements while the borehole 2 is being drilling or during a temporary halt in drilling in an application referred to as logging-while-drilling (LWD). In an alternative logging application referred to as wireline logging, the carrier 4 is an armored wireline configured to convey the neutron tool 10 through the borehole 2.

Still referring to FIG. 1, the downhole neutron tool 10 includes a neutron source 8 configured to irradiate the formation 4 with a flux of neutrons. In one or more embodiments, the neutron source 8 includes a chemical neutron source. The neutron tool 10 also includes a neutron detector 9 configured to detect neutrons resulting from interactions of the neutron flux with atoms in the formation 4. From the detection of the neutrons resulting from the interactions, one of more properties, such as density or porosity, can be determined.

Still referring to FIG. 1, the neutron detector 9 is coupled to downhole electronics 11. The downhole electronics 11 are configured to operate the downhole tool 10, process data from formation measurements, and/or provide an interface for transmitting data to a surface computer processing system 12 via a telemetry system. In one or more embodiments, the downhole electronics 11 can provide operating voltages to the neutron detector 9 and measure or count electrical current pulses resulting from neutron detection. Processing functions such as counting detected neutrons or determining a formation property can be performed by the downhole electronics 11 or the surface computer processing system.

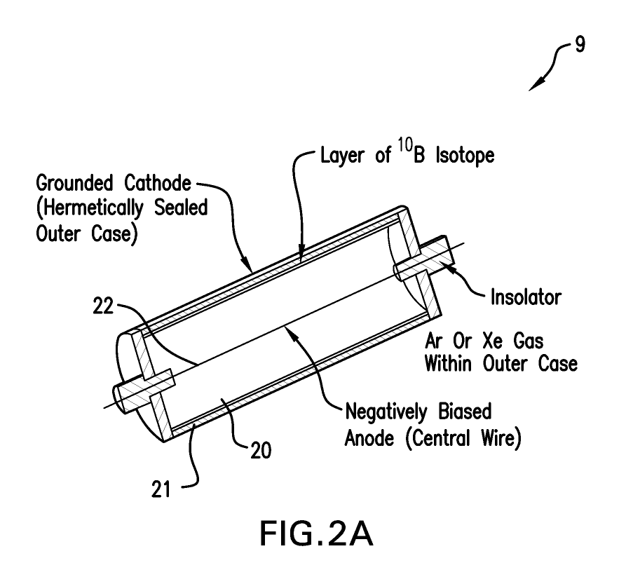

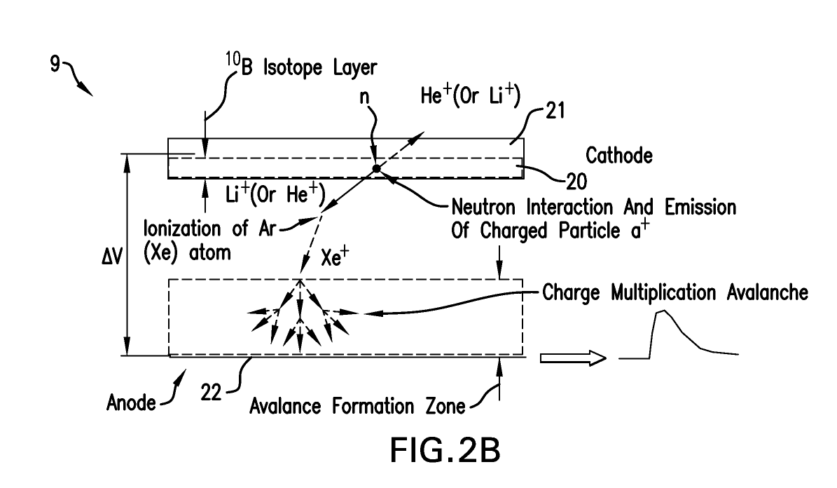

Referring now to FIG. 2, the neutron detector 9 includes a layer (20) of Boron-10 containing material lining a cathode 21 (i.e. outer case of detector) as illustrated in FIG. 2A. In general, the Boron-10 in the layer 20 is part of a chemical such as boron carbide, B₄C, lining the cathode. The neutron detector 9 uses the nuclear reaction of neutrons with the ¹⁰B isotope to convert neutrons into charged particles according to one of the following reactions (*).

$$\begin{matrix}n {+}^{10} B \to {}^{7} Li ( 1.0 MeV ) + {}^{4} He ( 1.8 MeV ) ; BR = 7 \% \\ \to {}^{7} Li ( 0.83 MeV ) + {}^{4} He ( 1.47 MeV ) + γ ( 0.48 MeV ) ; BR = 93 \%\end{matrix} \} \begin{matrix}{σ}_{tot} = 3840 b \\ (* )\end{matrix}$$

Shown here are values of reaction cross-section σ for thermal neutrons with energy Eₙ=0.025 eV.

An ionization process is used in the neutron detector 9 to convert charged particles formed in reaction (*) into electrical signals as illustrated in FIG. 2B. Here, a neutron interacts with a ¹⁰B nucleus in the layer 20 of boron-10 containing material deposited at the inner surface of the cathode 21. Two charged particles (Li ion and alpha particle) are formed in the reaction (*) and are emitted in opposite directions. One of these particles escapes the material layer (20) and enters the detector volume. This particle interacts with the gas (Ar or Xe mixed with quenching gas) located between cylindrical cathode 21 and an anode 22 in the form of thin wire mounted at the center axis of the cathode. In general, the cathode 21 is at the ground and the anode 22 is at positive potential ΔV with respect to the voltage of the cathode 21. The interaction of charged particles with a gas molecule or an atom between the cathode 21 and the anode 22 creates gas ions and free electrons, which are accelerated by an electric field between the cathode 21 and the anode 22. The charged particles and free electrons move toward the cathode 21 and the anode 22, respectively. These charges species interact with other gas species and can ionize them. As soon as they enter an avalanche formation zone of the detector (the area around the anode where electric field strength is high enough to create the avalanche ionization of the gas), the negative charge avalanche is formed and this charge is deposited at the anode wire 22 to form a pulse of electric current.

Depending on ΔV and detector geometry, the neutron detector 9 can be operated in any of three regimes. In a first ionization detector regime, there is not any substantial amplification of the charges created inside of the detector in the avalanche formation zone (i.e., no avalanche is formed) and the charge collected at the anode 22 is equal to the charge created by charged particles inside of the detector 9. In a second regime also referred as the proportional counter regime, charges created within the detector 9 are multiplied linearly by the avalanche and the charge collected at the anode 22 is proportional to the charge created by emitted charged particles in the detector 9. In a third regime referred to as the Geiger-Muller counter regime, charge multiplication in the avalanche has a very nonlinear character.

In one or more embodiments, the thickness of the layer (20) of Boron-10 containing material is between 1.2 and 1.5 μm in order to provide a high probability of escape of one of the charged particles formed in the reaction (*) into the space between cathode 21 and anode 22. As a result, in one or more embodiments, the thermal neutron detection efficiency of the Boron-10 lined detector 9 having a single Boron-10 containing layer 20 is about four percent. In one or more embodiments, the thermal neutron detection efficiency can be increased by stacking a plurality of individual cylindrical detectors 9 into hexagonally packed assemblies with the anodes 22 electrically interconnected. Three neutron detectors 9 of 4 mm outside diameter (OD) can be fit between the center axis and an outer shell of a one inch OD detector assembly and such assembly has a thermal neutron detection (DE) of up to twenty-five percent. For a one and a half inch OD assembly packed with the same neutron detectors 9 (i.e., 4 mm OD), the detection efficiency is up to forty percent. Detection efficiency can be increased even further by packing a plurality of assemblies into “super-assemblies” and so forth.

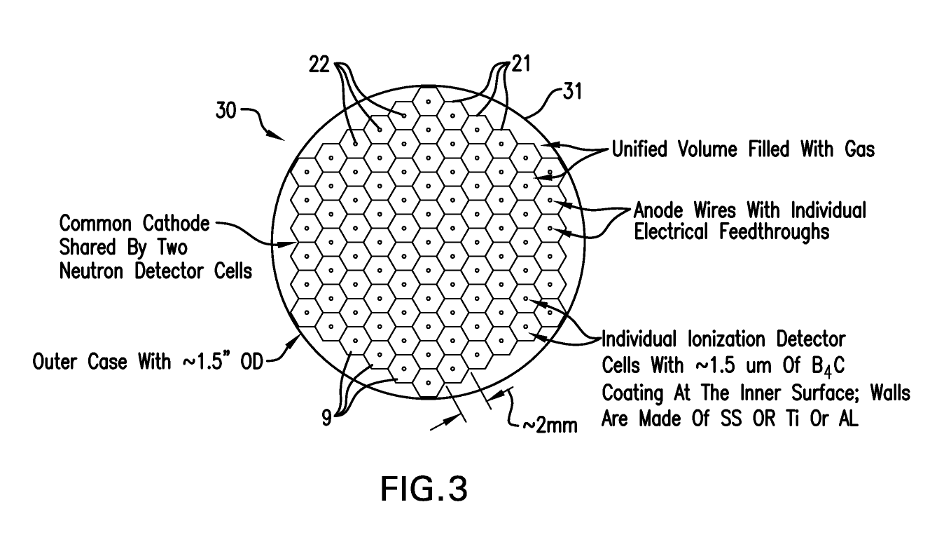

One technique to improve neutron detection efficiency is illustrated in the cross-sectional view in FIG. 3. In FIG. 3, the shape of each cathode 21 is configured to increase the density of a plurality of the neutron detectors 9 in a detector assembly 30 having an outer case 31. In the embodiment of FIG. 3, the cathodes 21 have a hexagonal shape. In one or more embodiments, each neutron detector 9 shares a common cathode wall with adjacent neutron detectors 9. Sharing a common cathode with adjacent neutron detectors is referred to as an “integrated cathode structure.” With such an integrated cathode structure, when individual detectors 9 (referred to as neutron detector cells 9 when having the integrated cathode structure) have the hexagonal shape and constitute each others cathode walls, the OD of individual cells can be decreased up to two millimeters. Such a decrease can allow enough neutron detector cells 9 to fit inside of a one and a half inch OD cylindrical outer case 31 to provide close to 100% detection efficiency of thermal neutrons. It should be pointed out that such a design with a honeycomb-like integrated cathode structure possesses mechanical robustness high enough to withstand shocks and vibration levels of an LWD environment.

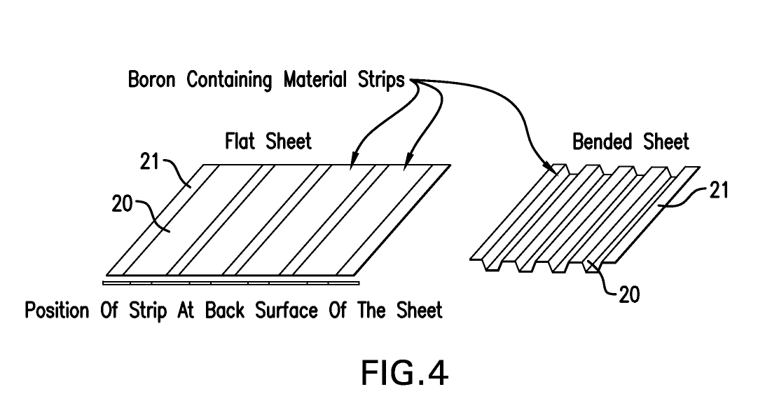

Two approaches can be used to manufacture the integrated honeycomb cathode structure illustrated in FIG. 3 in which internal cathode surfaces are coated with B₄C material or other Boron-10 containing material. In one approach, the integrated structure is manufactured separately from bended thin metal sheets, which are spot-welded together, or by electro-etching cells from a solid piece of metal and then depositing the layer of boron carbide on the internal surfaces such as by an atomic layer deposition technique. Non-limiting embodiments of the metal include stainless steel, titanium or aluminum alloys. In another approach, the layer 20 of Boron-10 containing material is deposited in the form of strips on both sides of a metal sheet by evaporation, sputter coating, electrochemical deposition or painting, as non-limiting examples. Then, the metal sheet is bent at a 120-degree angle along strip boundaries as illustrated in FIG. 4. The bent metal sheets are then spot-welded or brazed to form the honeycomb integrated cathode structure with internal surfaces coated or covered with Boron-10 containing material.

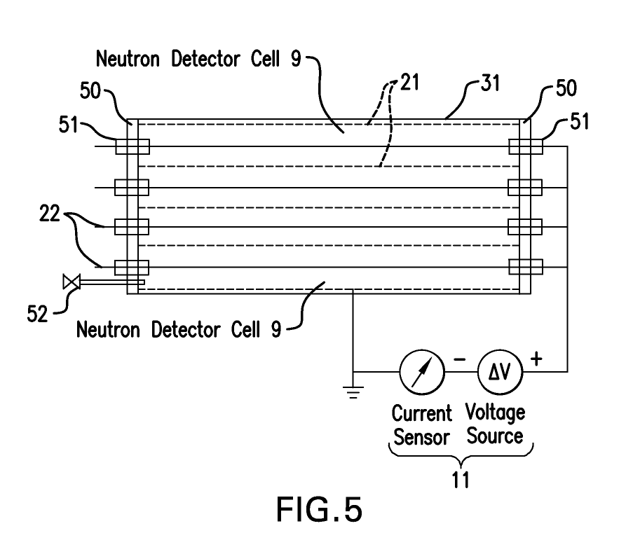

After the honeycomb integrated cathode structure is formed, it is inserted into the cylindrical outer case 31, which in one or more embodiments is about the same length as the integrated cathode structure. In one or more embodiments, the integrated cathode structure is attached to the outer casing 31 by spot-welding, adhesive or other technique. The ends of the outer casing 31 are covered and sealed vacuum-tight with end lids 50 as illustrated in a cross-sectional view in FIG. 5. One or more of the end lids 50 have sealed electrical feed-throughs 51. Each electrical feed-through 51 is located at the center of a corresponding cell 9 of the honeycomb structure. Anode wires 22 are installed at the central axis of each cell 9 through the corresponding feed-through and sealed. The inner volume of the casing 31 is evacuated through a valve 52 and an appropriate mixture of inert gas (such as Argon or Xenon) with quenching compound is then filled inside of the casing 31 through the same valve 52. In one or more embodiments, all the cathodes 21 and the casing 31 are tied together at the same electrical potential while all the anodes 22 are also tied together at the same potential ΔV.

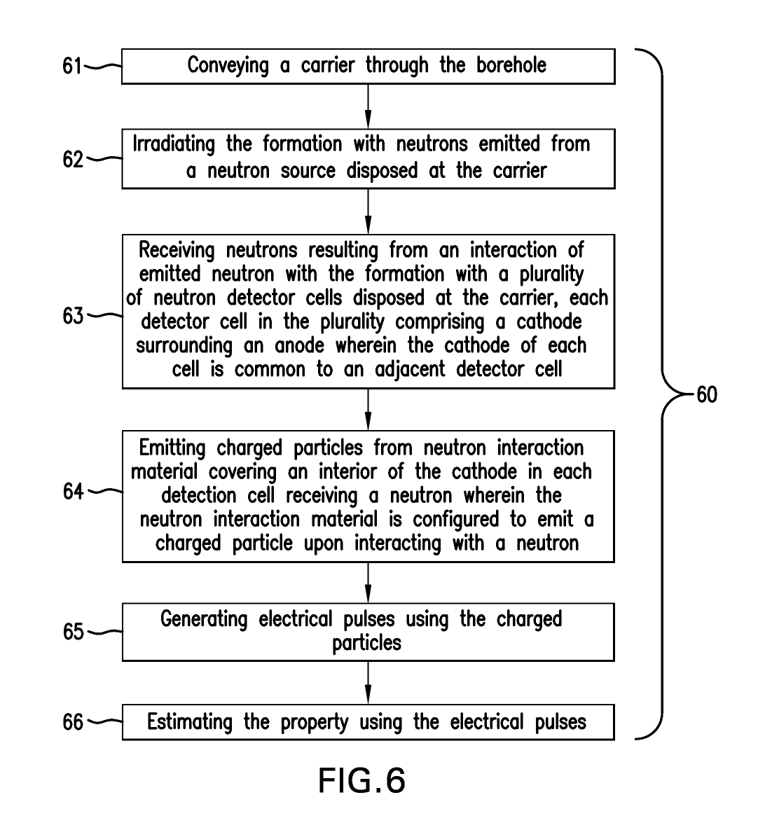

FIG. 6 presents one example of a method 60 for estimating a property of an earth formation. The method 60 calls for (step 61) conveying a carrier through the borehole. Further, the method 60 calls for (step 62) irradiating the formation with neutrons emitted from a neutron source disposed at the carrier. Further, the method 60 calls for (step 63) receiving neutrons resulting from an interaction of emitted neutron with the formation with a plurality of neutron detector cells disposed at the carrier, each detector cell in the plurality comprising a cathode surrounding an anode wherein the cathode of each cell is common to an adjacent detector cell. The term “common” relates to at least a portion of the cathode structure of one neutron detector cell being used as at least a portion of the cathode structure of an adjacent neutron detector cell. Further, the method 60 calls for (step 64) emitting charged particles from neutron interaction material covering an interior of the cathode in each detection cell receiving a neutron wherein the neutron interaction material is configured to emit a charged particle upon interacting with a neutron. Further, the method 60 calls for (step 65) generating electrical pulses using the charged particles. Further, the method calls for (step 66) estimating the property using the electrical pulses. The method 60 can also include ionizing a gas disposed between the anode and cathode with the charged particles to generate ions and collecting the ions at the cathodes to generate the electrical pulses. The method 60 can further include counting the generated electrical pulses to estimate the property.

It can be appreciated that while the integrated cathode structure was discussed above with respect to having a hexagonal shape, other shapes or combination of different shapes allowing a common cathode 21 between adjacent neutron detector cells 9 may also be used.

In support of the teachings herein, various analysis components may be used, including a digital and/or an analog system. For example, the downhole electronics 11 or the surface computer processing system 12 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” and the like are used to distinguish elements and are not used to denote a particular order. The term “couple” relates to coupling a first component to a second component either directly or indirectly through an intermediate component.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for detecting neutrons, the apparatus comprising:
a plurality of neutron detector cells, each detector cell comprising a cathode surrounding an anode wherein the cathode of each cell is common to an adjacent cell; and
a neutron interaction material covering an interior surface of the cathode in each neutron detector cell, the neutron interaction material being configured to emit a charged particle between the cathode and the anode upon interacting with a neutron.

2. The apparatus according to claim 1, wherein each detector cell comprises a hexagonal shape.

3. The apparatus according to claim 2, wherein a distance between two parallel cathode surfaces is about two millimeters.

4. The apparatus according to claim 1, wherein each anode is disposed along a centerline of the corresponding cell.

5. The apparatus according to claim 1, wherein the plurality of detector cells is disposed in a casing.

6. The apparatus according to claim 5, wherein the casing is cylindrical.

7. The apparatus according to claim 5, wherein the cathode of each neutron detector cell is electrically tied to the casing.

8. The apparatus according to claim 5, wherein the anodes of the neutron detector cells are electrically tied together outside of the casing.

9. The apparatus according to claim 5, further comprising a lid configured to seal an end of the casing, the lid comprising a plurality of electrical feed-throughs configured to receive corresponding anodes.

10. The apparatus according to claim 5, further comprising a mixture of an inert gas and a quenching compound disposed within the casing, the inert gas being configured to be ionized by the charged particle.

11. The apparatus according to claim 1, wherein the neutron interaction material comprises Boron-10.

12. The apparatus according to claim 1, wherein the plurality of neutron detector cells comprises a first assembly of neutron detector cells and a second assembly of neutron detector cells, each assembly comprising an integrated cathode structure.

13. An apparatus for estimating a property of an earth formation penetrated by a borehole, the apparatus comprising:
a carrier configured to be conveyed through the borehole;
a neutron source disposed at the carrier and configured to irradiate the formation with neutrons;
a plurality of neutron detector cells disposed at the carrier, each detector cell comprising a cathode surrounding an anode wherein the cathode of each cell is common to an adjacent cell; and
a neutron interaction material covering an interior surface of the cathode in each neutron detector cell, the neutron interaction material being configured to emit a charged particle upon interacting with a received neutron to generate an electrical pulse between the cathode and the anode in the neutron detector cell that received the neutron;
wherein the electrical pulse is used to estimate the property.

14. The apparatus according to claim 13, wherein the carrier comprises a wireline, a drill string or coiled tubing.

15. The apparatus according to claim 13, wherein the electrical pulse is a current pulse.

16. The apparatus according to claim 13, wherein the property is density or porosity.

17. The apparatus according to claim 13, further comprising a processor coupled to the plurality of neutron detector cells and configured to estimate the property from electrical pulses generated in the plurality of neutron detector cells.

18. A method for estimating a property of an earth formation penetrated by a borehole, the method comprising:
conveying a carrier through the borehole;
irradiating the formation with neutrons emitted from a neutron source disposed at the carrier;
receiving neutrons resulting from an interaction of emitted neutron with the formation with a plurality of neutron detector cells disposed at the carrier, each detector cell in the plurality comprising a cathode surrounding an anode wherein the cathode of each cell is common to an adjacent detector cell;
emitting charged particles from neutron interaction material covering an interior of the cathode in each detection cell receiving a neutron wherein the neutron interaction material is configured to emit a charged particle upon interacting with a neutron;
generating electrical pulses using the charged particles; and
estimating the property using the electrical pulses.

19. The method according to claim 187, further comprising ionizing a gas disposed between the anode and cathode with the charged particles to generate ions and collecting the ions at the cathodes to generate the electrical pulses.

20. The method according to claim 18, further comprising counting the generated electrical pulses to estimate the property.
